(19) United States
(12) Patent Application Publication
(10) Pub. No.: US 2026/0286926 A1
(43) Pub. Date: Sep. 24, 2026

(54) Water powered Energy Conversion Using Buoyancy

(71) Applicant: David Poling, Rockaway, NJ (US)

(72) Inventor: David Poling, Rockaway, NJ (US)

(21) Appl. No.: 19/085,085

(22) Filed: Mar. 20, 2025

(51) Int. Cl. F03B 13/20

(52) U.S. Cl. CPC F03B 13/20; F05B 2210/18; F05B 2240/57; F05B 2260/4021; F05B 2260/4031; F05B 2260/64

(57) ABSTRACT

A fluid-based apparatus that converts buoyancy to mechanical energy with a vertically extending tube filled with water housing an interior water filled cylinder. Motion of the cylinder through the tube along the y-axis moves a cord correspondingly, thus turning the pulleys and associated gears. Beneath the tube is a lower chamber filled with air. When the cylinder is at the bottom of the tube, the air of the lower chamber is released into the cylinder, causing the cylinder to increase in buoyancy and rise. Water that displaces the air in the lower chamber is pumped back into the main tube, and air once again occupies the lower chamber. Upon reaching the top of the tube, an air-tight seal of the cylinder is broken and the cylinder sinks towards the lower chamber. Once the cylinder reaches the bottom of the tube, the cycle of air/water displacement and water pumping recommences.

### BACKGROUND OF THE DISCLOSED TECHNOLOGY

Current market dynamics in chemical storage present significant operational challenges. Battery production requires substantial capital investment in raw material extraction, with associated environmental compliance costs. The lithium supply chain, concentrated in South America, faces increasing scrutiny over water resource management, while cobalt extraction continues to present environmental risks. Hydrogen storage alternatives, while promising, remain capital-intensive due to electrolysis infrastructure requirements and ongoing operational costs, particularly in regions without access to low-cost renewable energy.

While recycling technologies exist, they require significant operational expenditure and specialized facilities. Environmental liability risks from improper disposal represent a material concern for stakeholders, particularly given strengthening environmental protection frameworks in key markets.

In contrast, physical storage solutions offer compelling advantages in both cost structure and environmental compliance. Pumped hydro storage facilities leveraging existing water infrastructure demonstrate strong return on investment through reduced capital requirements and streamlined permitting processes. These assets frequently create positive externalities through flood management capabilities and ecosystem services, potentially opening additional revenue streams through environmental credits or municipal partnerships. Recent innovations in seawater and brownfield site adaptation have further improved the business case for pumped storage by reducing land acquisition costs and environmental mitigation requirements.

Compressed air energy storage (CAES) in natural geological formations represents another capital-efficient approach. This technology offers minimal surface footprint and reduced environmental compliance requirements compared to alternative storage solutions. Initial development costs are front-loaded, but ongoing operational expenses remain low, contributing to attractive lifetime project economics.

From a total cost of ownership perspective, physical storage solutions typically outperform chemical alternatives. Their reduced reliance on raw material supply chains mitigates commodity price exposure, while their ability to integrate with natural systems often results in lower environmental compliance costs. These facilities generally maintain strong asset values through their operational life and present minimal decommissioning liabilities. When integrated into renewable energy portfolios, physical storage assets can enhance overall project returns while meeting increasingly stringent ESG requirements from investors and regulators.

What is needed is a way to provide less expensive devices and methods to store energy using natural resources such as air and water.

### SUMMARY OF THE DISCLOSED TECHNOLOGY

An object of the invention is to provide a cheaper mechanism to store energy than a chemical battery. A further object of the invention is to use water, air, and buoyancy, to store potential energy and release kinetic energy.

The disclosed technology relates to an apparatus and method for converting buoyancy into mechanical energy. The system comprises several interconnected components that work together to harness buoyant force and convert it into rotational motion, which can then be used for mechanical energy generation. The apparatus includes a vertical tube filled with water and a water-fillable (defined as, “having at least one portal large enough to receive liquid, and a vessel sealed such that received liquid is held therein”) buoyant cylinder that moves vertically within the tube. The cylinder is connected to a cord, which engages with at least one pulley, and at least one gear is driven by the pulley system to produce mechanical energy. This system efficiently converts buoyant energy into mechanical energy and offers potential for further conversion into electrical energy, providing an innovative solution for sustainable energy generation.

The apparatus has a vertical tube which is selectively filled with water causing a buoyant cylinder to move. The tube provides a location for vertical motion of the cylinder. “Vertical”, for purposes of this disclosure, is defined as “substantially along in axis in a vector direction of the pull of gravity” and/or “along an axis which is the most elongated length of the vertical tube”. A water fillable cylinder which is selectively water proof (closed to the passage of water) at the bottom side and side walls is positioned within the vertical tube. The cylinder, in embodiments of the disclosed technology, can be filled with air causing the cylinder to be buoyant. This buoyancy causes the cylinder to rise within the tube. A cord is attached to the buoyant cylinder, the cord used to transfer the vertical motion of the cylinder to the pulley system, which, in turn, converts movement of the cylinder within the type into rotational motion. A pulley system as at least one pulley which interfaces with (is fixedly attached to, during operation of the device) the cord attached to the cylinder. As the cylinder moves vertically within the tube, the cord rotates the pulley. The pulley system is coupled to at least one gear such that as the pulley rotates, the gear is driven and starts to rotate as well, converting the vertical motion of the cylinder into mechanical rotational energy. A chamber beneath the vertical tube is filled with air. This chamber selectively opens into (communicates with) the cylinder via an air release valve, allowing the air to flow into the cylinder to add force moving the cylinder in an upward direction. (“Upward” is along the vertical axis and away from or opposite a direction of pull of gravity, or what we perceive to be gravity on the earth.) The air release valve connects the lower air chamber to the cylinder and controls the release of air, allowing the cylinder to ascend as the cylinder fills with air and to descend when the air is released.

The disclosed technology can further include additional mechanisms and methods as follows. The cylinder may include a sealing mechanism that creates an airtight seal when air is injected into the cylinder from the lower chamber. This ensures that the cylinder remains buoyant as the air ascends through the water-filled tube. Once the cylinder reaches a predetermined height within the vertical tube, a release mechanism breaks the airtight seal, allowing the air to escape. This causes the cylinder to lose buoyancy and descend back to the bottom of the tube. The system may also include a water pump that facilitates the movement of displaced water from the lower chamber back into the vertical tube. This ensures that the water level within the tube remains stable and supports the continuous operation of the system.

A method for converting buoyancy to mechanical energy involves the following steps, any order: positioning the cylinder within the tube; filling the vertical tube with water; injecting air into the cylinder from the lower chamber when the cylinder reaches the bottom of the tube, causing the cylinder to rise due to buoyancy; rotating the pulley system via the cord attached to the rising cylinder; converting the rotational motion of the pulley into mechanical energy through the gear system; at the top of the tube, releasing air from the cylinder removing the buoyant property of the cylinder causing the cylinder to descend. After these steps displaced water is pumped from the lower chamber back into the vertical tube, ensuring a continuous cycle of buoyant motion.

In some embodiments, the rotational motion generated by the gear system can be further converted into electrical energy, providing a clean source of energy. An energy conversion system based on the disclosed technology includes the following elements: a vertical water-filled tube; a buoyant cylinder that moves vertically within the tube; an air chamber positioned below the tube; air injection and release valves connected to the cylinder for controlling the air supply; a cord attached to the cylinder and a pulley system for translating the vertical motion into rotational motion; and gears driven by the pulley system to convert the motion into mechanical energy.

“Buoyancy” is defined as “the vertical force, away from a direction of gravity, exerted by a fluid such as water that opposes the weight of an object (such as the cylinder) submerged therein” This force causes the cylinder to rise within the tube. The “sealing mechanism” is a device that ensures an airtight seal within the cylinder to trap air and maintain buoyancy until the desired height is reached. The “seal release mechanism” is a mechanism that breaks the airtight seal, releasing the trapped air and causing the cylinder to descend under gravity.

A “gear” is defined as “a rotating machine part with teeth that engage with another gear or component, converting rotational motion into mechanical energy and/or work”.

### BRIEF DESCRIPTION OF THE DRAWINGS

FIG. 1 shows a mechanical tube with floating cylinder of an embodiment of the disclosed technology.

FIG. 2 shows a first step of filling a cylinder with water, in an embodiment of the disclosed technology.

FIG. 3 shows the captured air causing the buoyant cylinder to float upwards in an embodiment of the disclosed technology.

FIG. 4 shows a buoyant cylinder reaching a top of a water line in an embodiment of the disclosed technology.

FIG. 5 shows a closeup side elevation view of the buoyant cylinder and parts of FIG. 4.

FIG. 6 shows a buoyant cylinder falling downwards below the water line in an embodiment of the disclosed technology.

FIG. 7 shows the buoyant cylinder sinking to the bottom of the vertical cylinder.

FIG. 8 shows a detailed view of the buoyant cylinder and associated parts used in an embodiment of the disclosed technology.

FIG. 9 shows the device with the vertical tube there-on in an embodiment of the disclosed technology.

FIG. 10 shows a water reservoir used in embodiments of the disclosed technology.

FIG. 11 shows the lower air chamber and water reservoir in an embodiment of the disclosed technology.

### DETAILED DESCRIPTION OF EMBODIMENTS OF THE DISCLOSED TECHNOLOGY

The disclosed technology provides a system for converting buoyancy into mechanical energy, utilizing a buoyant cylinder that moves vertically within a water-filled tube. The upward motion of the cylinder, caused by buoyancy, is harnessed through a pulley and gear mechanism to generate rotational motion, which can be used to produce mechanical or electrical energy. The system is designed to be self-sustaining, with the buoyant cylinder rising and falling through a vertical tube, while the displacement of water and air is controlled to maintain the movement and energy generation. This technology offers an innovative way to utilize buoyancy-driven motion for energy conversion.

Embodiments of the disclosed technology will become more clear in view of the following description of the figures.

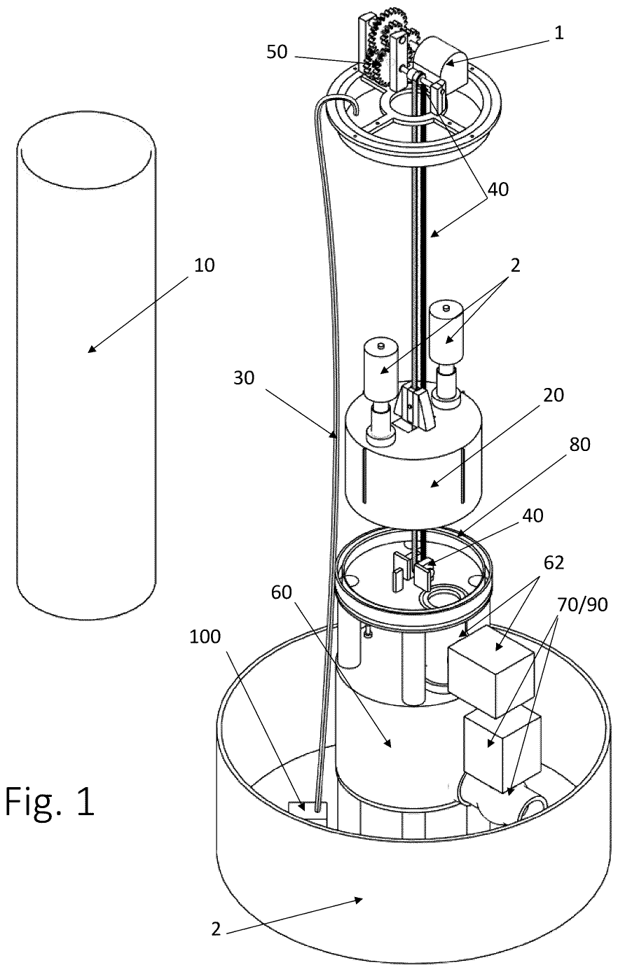

FIG. 1 shows a mechanical tube with floating cylinder of an embodiment of the disclosed technology. The vertical tube 10 (large cylinder) is filled with water. The vertical tube 10 is a structure that holds water, which in turn, causes the buoyant cylinder to move vertically upwards. “Vertically” is defined as “perpendicular to the pull of gravity” and “upwards” is “a vector direction opposite the pull of gravity” whereas “downwards” is “in a vector direction of the pull of gravity.” The tube has an interior space with cross-sectional area larger than that of the cross-section of a buoyant cylinder 20, the buoyant cylinder which floats on water. As such, when the vertical tube 10 fills with water, the buoyant cylinder 20 floats upwards due to its buoyancy. The buoyant cylinder may be filled with air to create buoyancy.

The vertical tube 10, as well as each of, or all of, the devices shown in FIG. 1 are made from durable, water-resistant materials including PVC, acrylic, or a metal which is solid at room temperature.

The cord 30 is a flexible, durable length of hollow material that is connected to a pump located in the bottom chamber 2, and fluidly allows movement of water into cylinder 10, raising the water level in the cylinder. “Flexible” is defined as, “bending easily without breaking” such as bending by way of the force of flowing water within the vertical tube during designed and/or ordinary use of the devices. Such a cord 30 may be made from synthetic or nature fibers or metals.

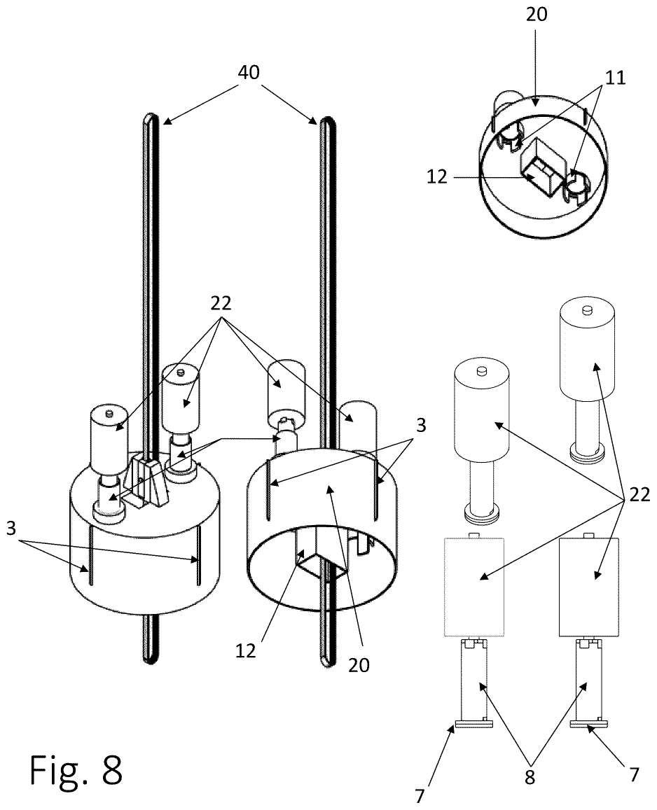

The pulley 40 (which can be single pulley, as shown, or a combination of pulleys in a pulley system) is fixedly (though, in embodiments of the disclosed technology, removably) attached to the buoyant cylinder 20. The pulley rotates when the cord moves, converting vertical motion of the buoyant cylinder 20 into rotational motion of by way of the gear mechanism 50. The gear mechanism is a set of gears that engage with a rotating pulley shaft. The gears may be part of a gear train to increase rotational speed and/or torque. A gear shaft or pulley shaft 12 connects the gears and transfers the rotational motion to additional mechanical systems, providing a mechanical link between the gears and other moving parts, such as a generator or other energy conversion devices (see FIG. 8).

A lower air chamber 60 fills with air, the lower air chamber being below the vertical tube 10, as the cylinder 10 fills with water. This, in turn, causes the buoyant cylinder 20 to float. When the air is released by the valve 62, water from the main chamber 10 fills the chamber 60. An air injection valve 62 controls the flow of air from the lower air chamber into the buoyant cylinder. As such, the valve regulates the release of air into the cylinder, enabling the cylinder to rise due to buoyancy when air is introduced therein. A complementary air release valve 2 opens to release air from the buoyant cylinder once the cylinder 20 has reached a predetermined height. When the air release valve 2 opens, the buoyant cylinder 20 descends within the vertical tube.

A sealing mechanism 7 creates an airtight seal inside the cylinder when air is injected therein. Such a mechanism can be a rubber or silicone gasket. The sealing mechanism 7 (e.g. gasket) keeps air trapped inside the cylinder 20, such that buoyancy is maintained and the cylinder 20 rises within the vertical tube 10 as the vertical tube is filled with water. Conversely, a complementary sealing release mechanism 2, such as the air release valve, breaks the airtight seal once the cylinder reaches a specific height. When the air is released from the cylinder 20, the buoyant cylinder descends the tube 10 based on gravity.

The specific mechanisms are described in more detail below with respect the remaining figures.

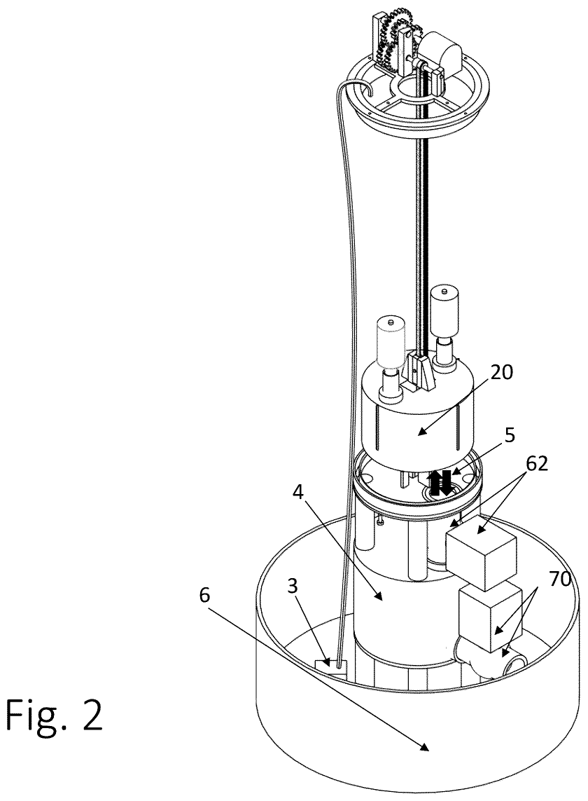

FIG. 2 shows a first step of filling a cylinder with water, in an embodiment of the disclosed technology. The mechanical valve 62 is triggered by an outside force, such as a person opening the valve, electric stimulus of a solenoid, or a mechanical gate. Water from the main cylinder 10 fills the bottom of the chamber 4 and pushes the air 5 out of the lower portion 4 into the buoyant cylinder 20 causes the cylinder to rise in a tube of water, the tube being the vertical tube 10 which fills with water. When valve 62 opens water begins to fill the lower chamber 4, pushing the trapped air inside the lower chamber 4, forcing the air upwards into the main cylinder 10, forcing the buoyant cylinder 20 to capture the air and become buoyant. A mechanical value 62 closes a second mechanical valve 70 opens and water is drained from the bottom chamber back into the large reservoir 2 at the bottom.

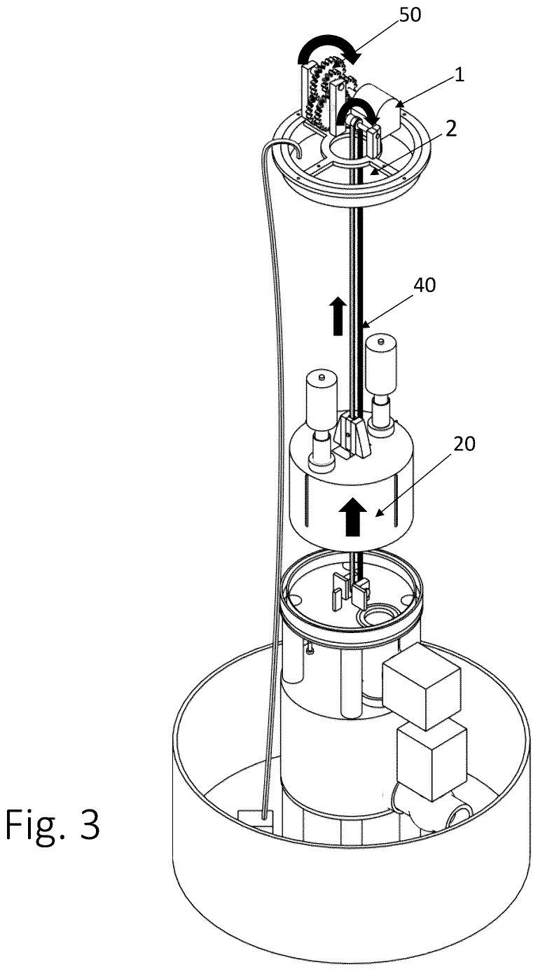

FIG. 3 shows the captured air causing the buoyant cylinder to float upwards in an embodiment of the disclosed technology. The air in the buoyant cylinder 20 causes the cylinder 20 to be floatable on water. “Water” is defined as a liquid with at least 90% hydrogen-dioxide and/or a liquid with a buoyancy of 0.9 to 1.1.

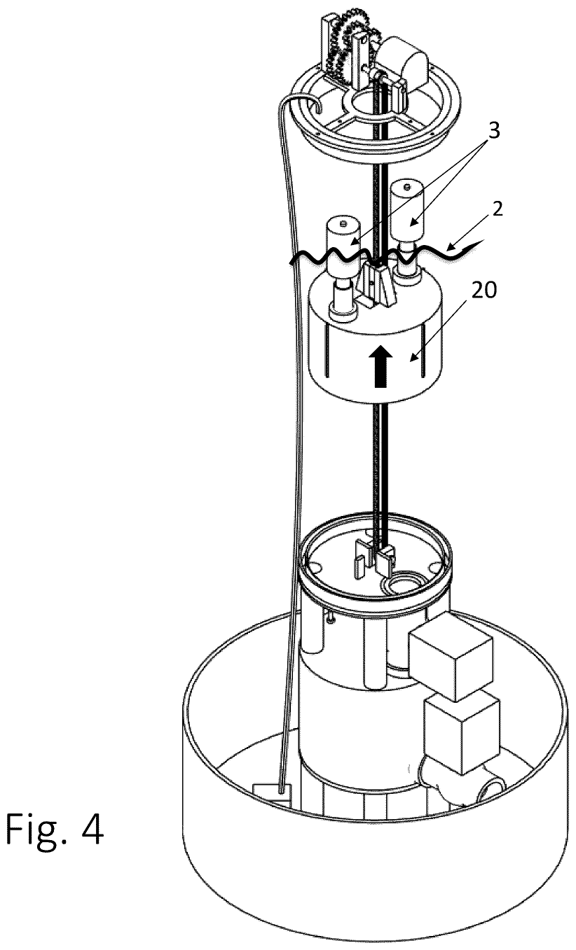

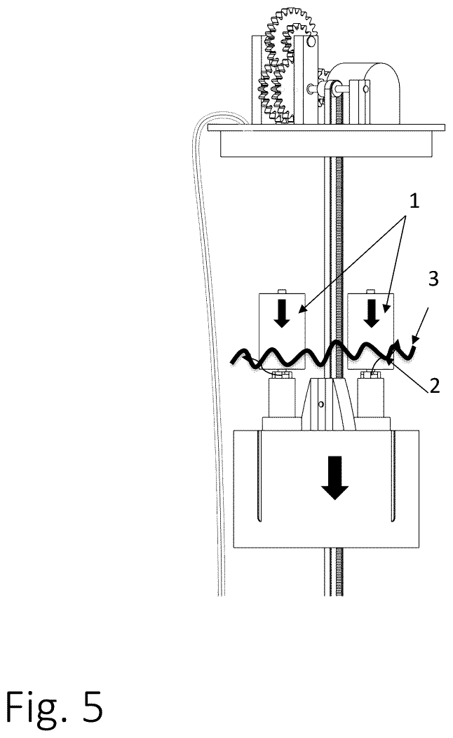

FIG. 4 shows a buoyant cylinder reaching a top of a water line in an embodiment of the disclosed technology. FIG. 5 shows a closeup side elevation view of the buoyant cylinder and parts of FIG. 4. Here, the buoyant cylinder 20 has floated/moved upwards due to the increase in water level 2 within the tube 10 and the buoyancy of the cylinder 20 causing the cylinder 20 to move upwards. The bobbers 1, which were sealed when below the water line, are now above the water level 2 causing the seal to break allowing air within the buoyant cylinder to escape, as explained in the next figure. A bobber is a type of float which floats on a surface of water. In this case, the bobber determines the state of a valve there-beneath (open/closed), described below.

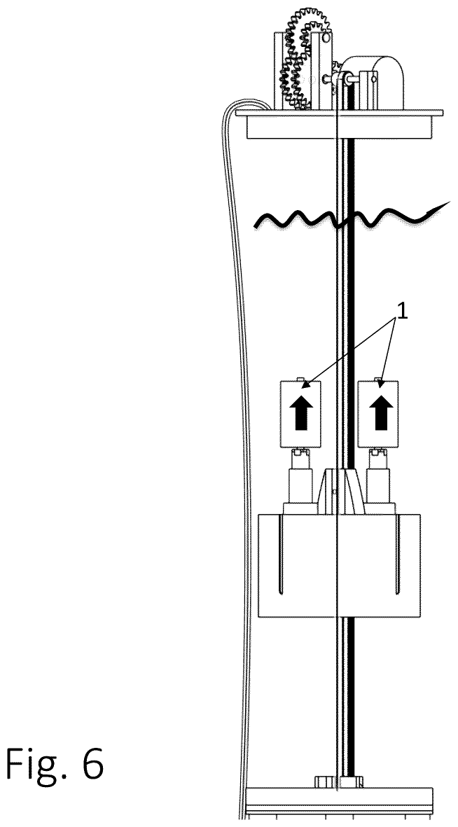

FIG. 6 shows a buoyant cylinder falling downwards below the water line in an embodiment of the disclosed technology. The bobbers 1 become submerged again creating a seal preventing air from escaping from the cylinder a second time. Once the bobbers 1 move downwards in the water (due to the opening of the air chamber into the buoyant cylinder 20, causing the cylinder, and with the cylinder, the bobbers attached thereto), a seal is recreated due to the lifting of bobbers relative to the cylinder. That is, when the bobbers 1 are upwards/further from the rest of the buoyant cylinder 20, an air outlet is closed into the buoyant cylinder. This occurs when the bobbers (and cylinder) are submerged in water. Once above water, the mass of the bobbers 1 causes same to press against the buoyant cylinder 20, thereby opening the air outlet releasing air.

In another embodiment, the bobbers 1, when submerged, are creating a seal. The seal is only broken and the air is released when the bobbers are pushed above the waterline.

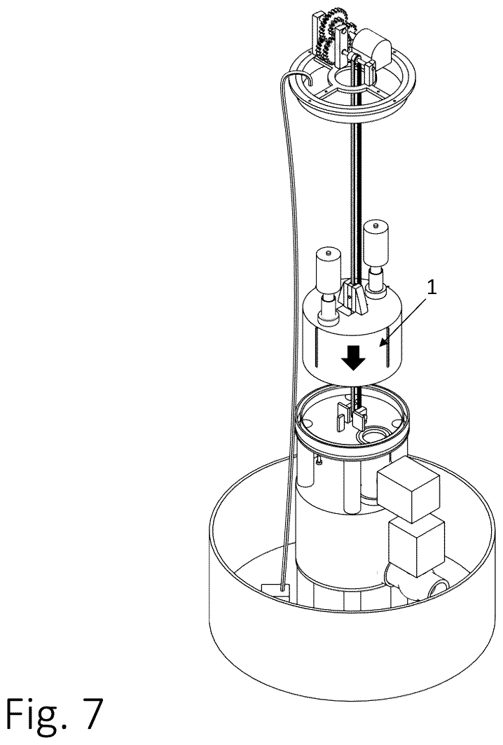

FIG. 7 shows the buoyant cylinder sinking to the bottom of the vertical cylinder. Once this step is accomplished, the method of use repeats again from the first step, described above with reference to FIGS. 1 and 2.

FIG. 8 shows a detailed view of the buoyant cylinder and associated parts used in an embodiment of the disclosed technology. Bobber guides 11 are portals within a top cover/top side of the buoyant cylinder 20. The bobber guides 11 ensure that when the bobber moves downwards, the bobber 20 returns to the correct place on the horizontal axis. Passing through these portals are lower ends of the bobbers 1. Spacers 3 creates a separation between the cylinder 20 and cylinder 10 so that water can pass there-between.

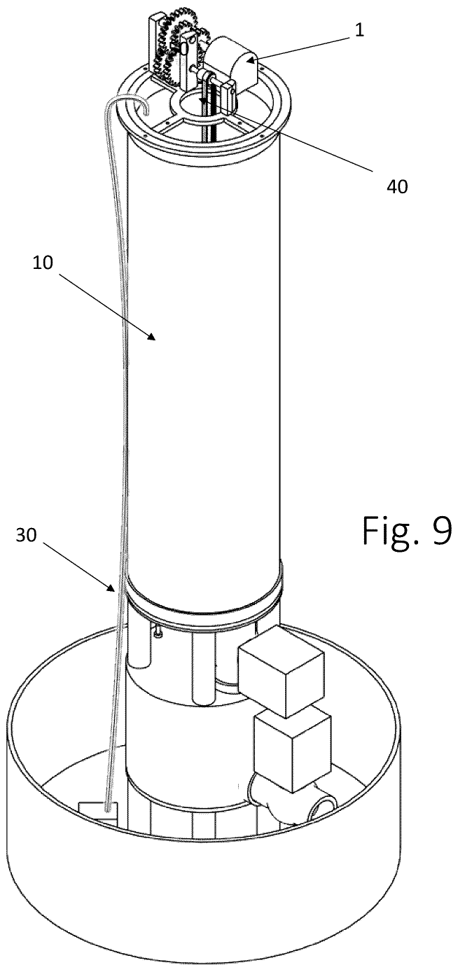

FIG. 9 shows the device with the vertical tube there-on in an embodiment of the disclosed technology. The vertical tube collects the water and is a location wherein the buoyant cylinder 20 rises with the water level.

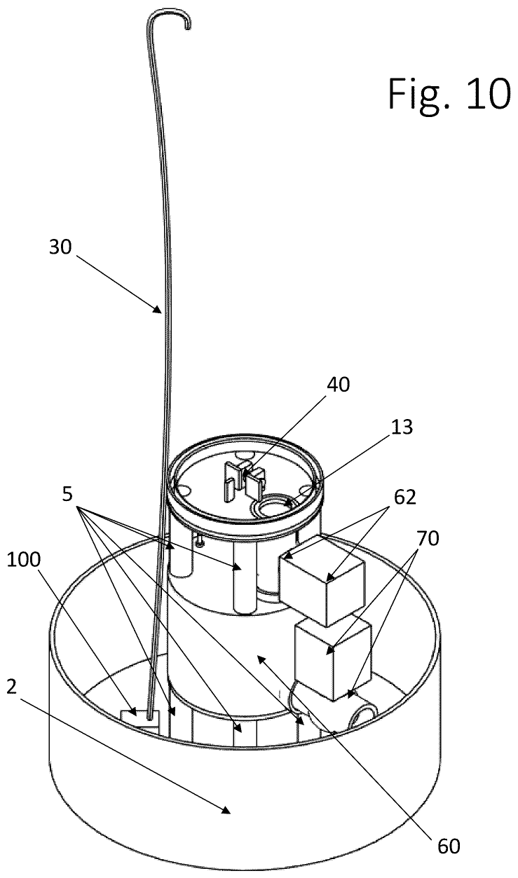

FIG. 10 shows a water reservoir used in embodiments of the disclosed technology. The reservoir 2 surrounds at least some of the longitudinal height of the lower air chamber 60. A lower end of the pulley 40 system afore-described is attached within the support column 5. The water pump 100 move water from the lower chamber back into the vertical tube after a cycle and is powered by way of a motor or other type of movement causing system. A pump, instead or in addition, could be used to pump water to the top of the device.

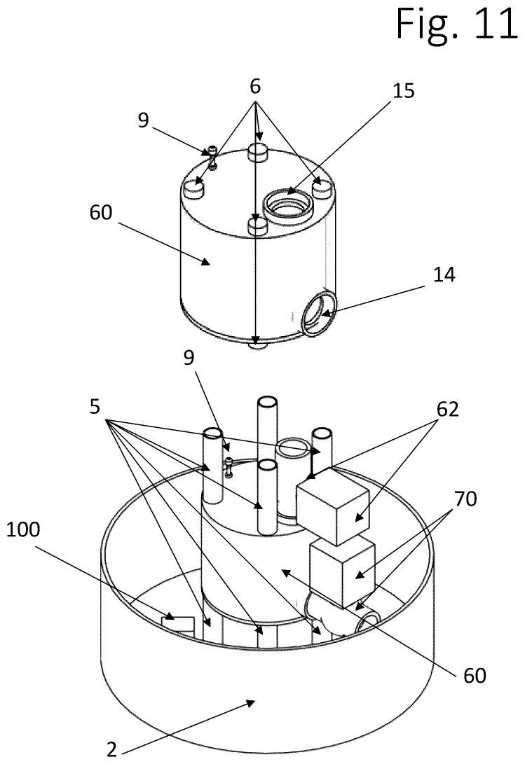

FIG. 11 shows the lower air chamber and water reservoir in an embodiment of the disclosed technology. Here, the lower air chamber 60 which is part of the buoyant cylinder 20, has connectors 6 which are designed to attach to support columns 5. Note also the one way air valve 9 allowing for air to enter the chamber only. The air valve 9 is needed in embodiments of the disclosed technology allowing water to drain more quickly, as a second location where the air can enter (and not exit) the chamber. The air coming into the chamber fills the place where the water was, allowing the water to be quickly exit therefrom the chamber.

It can now be appreciated how to operate the device to conserve and use energy. The operation of the disclosed technology follows a cycle of buoyancy-driven movement that converts vertical motion into rotational motion. The steps of the method are as follows: The vertical tube is filled with water, providing the environment in which the buoyant cylinder can move. The buoyant cylinder 20 is positioned at the bottom of the tube. The air and water are exchanged via valve 60 and through opening 15 (see FIG. 11). Valve 9 assisted the lower cylinder 60 in draining collected water. When air fills the cylinder, the cylinder to rises due to buoyancy. As the cylinder rises, it rotates the pulley system 40. The pulley system 40 engages the gear mechanism 50, converting the rotational motion into usable mechanical energy. Once the cylinder 20 reaches a top position, the sealing mechanism breaks an airtight seal in the cylinder, releasing air inside. The air release valve under bobbers 1 is triggered to release the air from the cylinder, breaking the airtight seal and allowing the cylinder to descend. The descending cylinder displaces water, which is pumped by the water pump 100 back into the vertical tube, maintaining the water level and enabling continuous buoyant motion. The entire process repeats in a cyclical manner, providing a continuous source of mechanical or electrical energy.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods and apparatuses described hereinabove are also contemplated and within the scope of the invention.

“Substantially” and “substantially shown,” for purposes of this specification, are defined as “between and including 90% to 100%,” or as otherwise indicated. “Identical” or “exactly,” for purposes of this specification, is defined as “within an acceptable tolerance level known in the art.” Any device may “comprise,” or “consist of,” the devices mentioned there-in, as limited by the claims. Any element described may be one of “exactly” or “substantially,” as described.

It should be understood that the use of “and/or” is defined inclusively, such that the term “a and/or b” should be read to include the sets: “a and b,” “a or b,” “a,” or “b.”

1. An apparatus for converting buoyancy to mechanical energy, comprising:
a vertical tube containing water; a water-fillable cylinder housed within said vertical tube;
a cord attached to said cylinder; at least one pulley interfacing with said cord;
at least one gear mechanically coupled to said at least one pulley; a lower chamber beneath said vertical tube containing air; and
an air release valve connecting said lower chamber to said cylinder.

2. The apparatus of claim 1, further comprising: a sealing mechanism creating an air-tight seal in said cylinder when receiving air from said lower chamber; and a seal release mechanism breaking said air-tight seal when said cylinder reaches a predetermined height in said vertical tube.

3. The apparatus of claim 1, further comprising:
a water pump connecting said lower chamber to said vertical tube.

4. A method of converting buoyancy to mechanical energy, comprising:
filling a vertical tube with water; positioning a cylinder within said vertical tube; releasing air from a lower chamber into said cylinder when said cylinder reaches a bottom position of said tube; causing said cylinder to rise through said tube from buoyancy; rotating at least one pulley via a cord attached to said cylinder; rotating at least one gear coupled to said at least one pulley; breaking an air seal of said cylinder at a top position of said tube causing water to enter said cylinder and said cylinder to descend through said tube; and pumping displaced water from said lower chamber into said vertical tube.

5. The method of claim 4, further comprising:
creating said air seal in said cylinder before releasing said air from said lower chamber.

6. The method of claim 4, further comprising:
converting rotational motion of said at least one gear to electrical energy.

7. An energy conversion system, comprising:
a vertical water-filled tube;
a buoyant cylinder moving within said tube; an air chamber below said tube; an
air injection valve connecting said air chamber to said cylinder; an air release valve on said cylinder; a cord attached to said cylinder; at least one pulley engaging said cord; and at least one gear driven by said at least one pulley.

8. The method of operating an energy conversion system, comprising:
filling a vertical tube with water; cycling a buoyant cylinder vertically within said tube by:
injecting air into said cylinder at a bottom position; causing said cylinder to rise from buoyancy; releasing air from said cylinder at a top position; causing said cylinder to descend; and converting vertical motion of said cylinder to rotational motion through a cord and pulley system.
